(19) United States
(12) Patent Application Publication
(10) Pub. No.: US 2026/0130351 A1
(43) Pub. Date: May 14, 2026

(54) FISHING REEL

(71) Applicant: Pure Fishing, Inc., Columbia, NC (US)

(72) Inventors: Yingdong QI, Guangzhou (CN); Sheng LI, Guangzhou (CN); Guohua ZANG, Guangzhou (CN); Liang HUANG, Guangzhou (CN)

(73) Assignee: Jia Dun Sports Equipment, Ltd., Guangzhou (CN)

(21) Appl. No.: 19/354,835

(22) Filed: Oct. 9, 2025

(30) Foreign Application Priority Data
Nov. 13, 2024 (CN) 202411620721.2

(51) Int. Cl. A01K 89/0155

(52) U.S. Cl. CPC A01K 89/01555

(57) ABSTRACT

A fishing reel is provided. The fishing reel includes a body, an end cover, a bearing, a spool portion and a brake system. The end cover is mounted at an axial end of the body, the end cover is formed with a first wall portion, and the first wall portion defines an accommodating cavity at its radial inner side. The bearing is embedded in the accommodating cavity. The spool portion is provided with a spool shaft, and the spool shaft is rotatably supported on the bearing in the accommodating cavity at its axial end. The brake system includes a coil and a magnet, the coil is mounted on one of the first wall portion and the spool shaft, the magnet is mounted on the other, and the coil and the magnet are opposite to each other along the radial direction of the spool shaft.

### CROSS REFERENCE TO RELATED APPLICATION

This application is based on and claims the benefit of priority from Chinese Patent Application No. 2024116207212, filed on Nov. 13, 2024, the entirety of which is incorporated by reference herein.

### TECHNICAL FIELD

The present disclosure relates to the technical field of fishing tackles, in particular to a fishing reel.

### BACKGROUND

In a fishing reel, such as a baitcasting reel, excessive spool rotation speed during a cast can cause the line to leave the spool faster than the lure travels. This causes the line to bunch up around the spool, resulting in “backlash”. To prevent this, a brake system is mounted that applies braking force to the spool. In such brake system, the braking force is generated through cooperation between a coil and a magnet. Furthermore, the magnitude of the braking force may be adjusted through a circuit board.

In the existing design, for example, in patent reference 1, a magnet is fixed on a spool shaft and a coil is fixed on an mounting base of a brake system, and the magnet and the coil are opposite to each other in a radial direction of the spool shaft. In this way, when the spool shaft rotates, the magnet and the coil interact to generate a braking force.

In patent reference 1, the spool shaft is supported on an end cover of a fishing reel through a bearing, and the mounting base is mounted to the end cover of the fishing reel in a screw locking manner, while the spool shaft rotates coaxially with respect to the mounting base. However, due to various assembly errors, especially in the case of inaccurate assembly, a coaxiality of the spool shaft and the mounting base will exceed an expected range.

### PRIOR ART REFERENCE

### Patent Reference

Patent reference 1: China Invention Patent Publication No. 106993591

### SUMMARY

In view of the above technical problems, the present disclosure aims at providing a fishing reel, which can improve an assembly precision.

A fishing reel according to the present disclosure comprises: a body, an end cover, a bearing, a spool portion and a brake system.

The end cover is mounted at an axial end of the body, the end cover is formed with a first wall portion, and the first wall portion defines an accommodating cavity at its radial inner side.

The bearing is embedded in the accommodating cavity.

The spool portion is provided with a spool shaft, and the spool shaft is rotatably supported on the bearing in the accommodating cavity at its axial end.

The brake system is provided with a coil and a magnet, the coil is mounted on one of the first wall portion and the spool shaft, the magnet is mounted on the other of the first wall portion and the spool shaft, and the coil and the magnet are opposite to each other along the radial direction of the spool shaft.

The fishing reel of the present disclosure has the beneficial effect that the assembly precision can be improved.

In some embodiments, the end cover is further formed with: a second wall portion surrounding the first wall portion; a first sealing wall sealing an opening defined by the first wall portion and the second wall portion at ends of the first wall portion and the second wall portion adjacent to an opening of the accommodating cavity; and a second sealing wall sealing the accommodating cavity at an end opposite to the first sealing wall, wherein the first wall portion, the second wall portion and the first sealing wall together define an mounting cavity; and the second sealing wall isolates the accommodating cavity and the mounting cavity from each other.

In some embodiments, the second sealing wall does not protrude from an end face of an axial end of the second wall portion opposite to the first sealing wall.

In some embodiments, the coil is accommodated in the mounting cavity and mounted on the first wall portion; the magnet is mounted on the spool shaft; and the coil and the magnet face each other across the first wall portion.

In some embodiments, a radius of a radial inner side wall surface of the first wall portion is larger than a rotation radius of the magnet by 0.30 mm to 0.50 mm.

In some embodiments, the end cover is further formed with a shielding cover, and the shielding cover and the first wall portion extend coaxially towards an opening side of the accommodating cavity; the spool portion is provided with a spool cylinder coaxial with the spool shaft, an annular flange portion is formed on an end of the spool cylinder corresponding to the shielding cover, and the flange portion extends into the shielding cover; and in a portion at which the shielding cover and the flange portion overlap each other in the axial direction, an outer diameter of the flange portion is smaller than an inner diameter of the shielding cover by 0.30 mm to 0.40 mm.

In some embodiments, a reinforcing cover plate is further provided, wherein the reinforcing cover plate is mounted in the mounting cavity and sleeved over the first wall portion.

In some embodiments, a nesting hole is formed in a middle portion of the reinforcing cover plate, an inner diameter of the nesting hole is the same as an outer diameter of the first wall portion, and the reinforcing cover plate is sleeved over the first wall portion through the nesting hole.

In some embodiments, an annular abutting portion is formed on an edge of the reinforcing cover plate, and an outer diameter of the abutting portion is the same as an inner diameter of a part of the second wall portion adjacent to the abutting portion in the radial direction.

In some embodiments, the brake system further includes a control panel, where the reinforcing cover covers the control panel in such a way that the abutting portion surrounds the control panel.

### BRIEF DESCRIPTION OF THE DRAWINGS

FIG. 1 is a perspective view of a fishing reel according to the present disclosure as viewed from a second end portion;

FIG. 2 is a perspective view of the fishing reel according to the present disclosure as viewed from a first end portion;

FIG. 3 is a sectional view of the fishing reel according to the present disclosure at the first end portion;

FIG. 4 is a schematic diagram of an essential portion in the sectional view of FIG. 3;

FIG. 5 is a perspective view of an embodiment of an end cover of the first end portion of the fishing reel viewed from an axial outer side; and

FIG. 6 is a perspective view of an embodiment of the end cover of the first end portion of the fishing reel viewed from an axial inner side.

### REFERENCE NUMERALS

101—body; 102—first end portion; 103—second end portion; 104—spool portion; 105 handle; 106—brake system; 107—shaft supporting portion; 107a—bearing; 108—spool shaft; 109—spool cylinder; 111—end cover; 112—side cover; 114—coil; 115—magnet; 116—control panel; 117—braking-dial input portion; 118—knob; 120—connecting shaft; 124—mounting lug; 147—mounting cavity; 147a—first cavity; 147b—second cavity; 186—first wall portion; 187—accommodating cavity; 188—first sealing wall; 189—second sealing wall; 190—first outer side wall; 191—second outer side wall; 192—base portion; 193—shielding cover; 194—reinforcing cover plate; 195—reinforcing portion; 196—nesting hole; 197—abutting portion; 198—flange portion; 199—second wall portion; D1—outer diameter of flange portion; D2—inner diameter of shielding cover; r1—radius of radial inner side wall surface of first wall portion; r2: rotation radius of magnet; and θ1—rotation center of spool shaft.

### DETAILED DESCRIPTION

Embodiments of the present disclosure will be described in detail below. Examples of the embodiments are illustrated in the accompanying drawings, where the same or like reference numerals throughout the figures indicate the same or like elements having the same or like functions. The embodiments described below with reference to the accompanying drawings are exemplary and are intended only to explain the present disclosure instead of being construed as limiting the present disclosure.

In the description of the present disclosure, it should be understood that, descriptions relating to orientation, for example, orientation or positional relationships indicated by “up”, “down”, “front”, “rear”, “left”, “right”, etc. are based on the orientation or positional relationships shown in the accompanying drawings, and are to facilitate the description of the present disclosure and simplify the description only, rather than indicating or implying that the device or element referred to must have a specific orientation or be constructed and operated in a specific orientation, and therefore cannot be construed as limiting the present disclosure.

In the description of the present disclosure, the meaning of “several” is one or more, the meaning of “a plurality of” is two or more, “greater than”, “less than”, “more than”, etc. are to be understood to exclude the given figure, and “above”, “below”, “within”, etc. are understood to include the given figure. If “first” and “second”, etc. are referred to, it is only for the purpose of distinguishing technical features, and shall not be understood as indicating or implying relative importance or implying the number of the indicated technical features or implying the sequence of the indicated technical features.

In the description of the present disclosure, unless otherwise explicitly defined, the words such as “set”, “install”, and “connect” should be understood in a broad sense, and those of ordinary skill in the art can determine the specific meanings of the above words in the present disclosure in a rational way in combination with the specific contents of the technical solutions.

In addition, in the description of the present disclosure, when referring to the description about diameter, radius, distance, thickness, and the like, “same” refers to the same fit relationship based on machinery, and may have an allowable error (tolerance) for a certain assembly relationship (such as clearance fit). When referring to the description about an axial direction, it refers to an axial direction of a spool shaft 108. When referring to the description about an outer side and an inner side, with a center of a cross section of an axial middle portion of the spool shaft 108 as a reference, a side farther away from the center in the radial or axial direction of the spool shaft 108 is regarded as the “outer side”, and a side closer to the center in the radial or axial direction is regarded as the “inner side”.

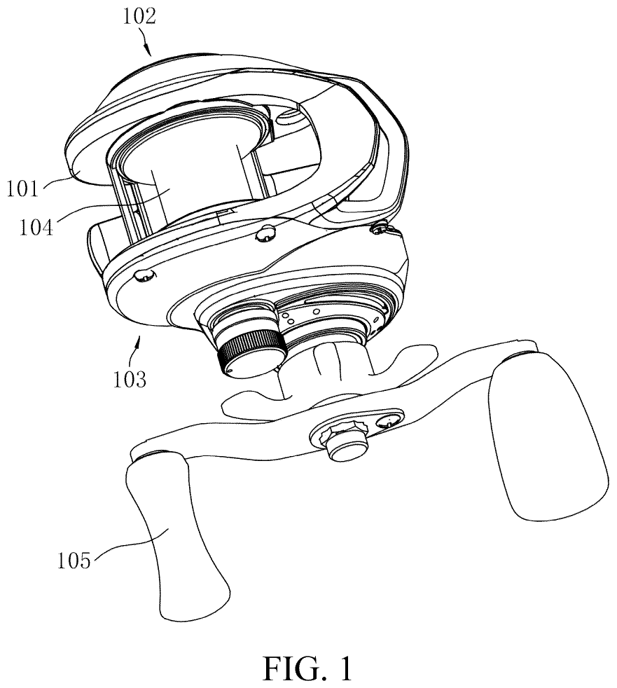

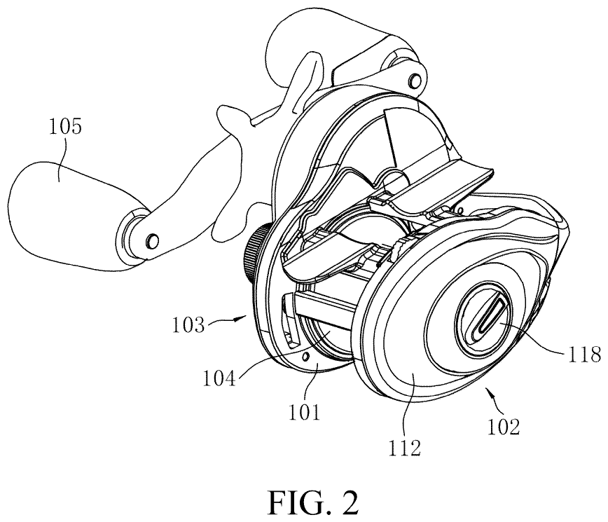

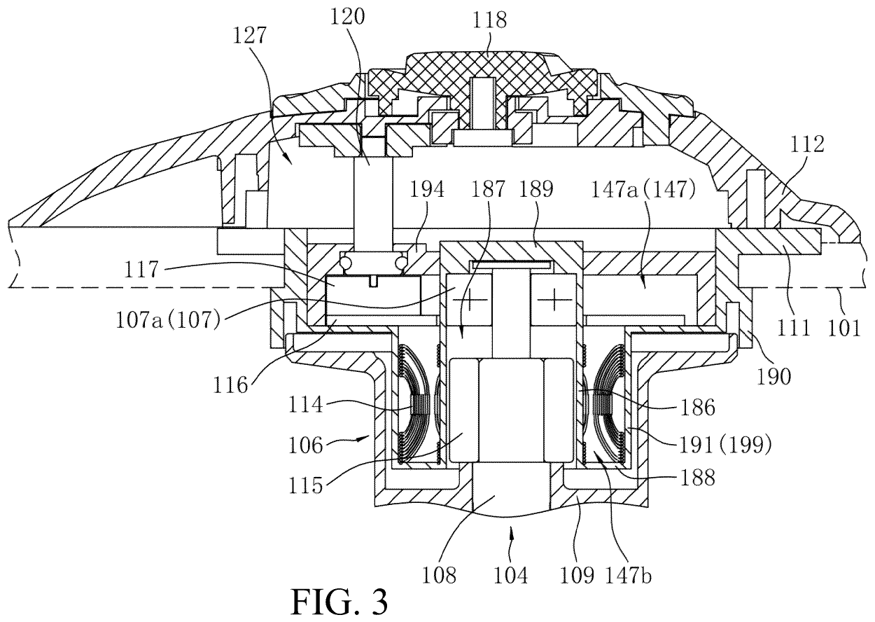

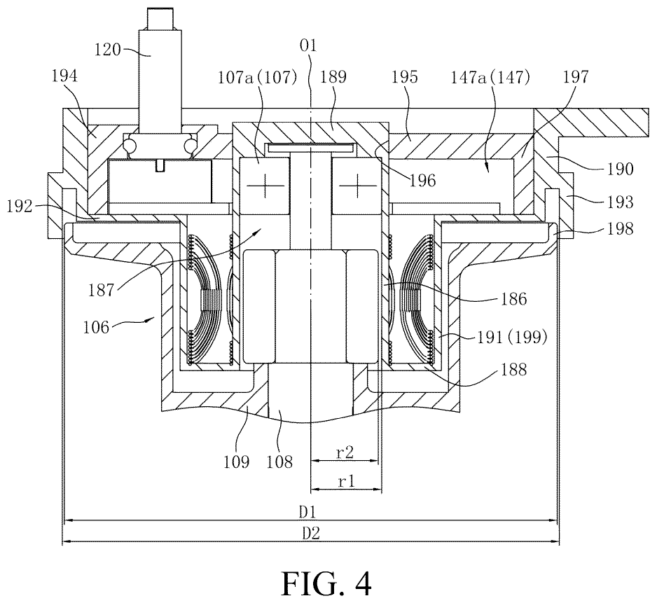

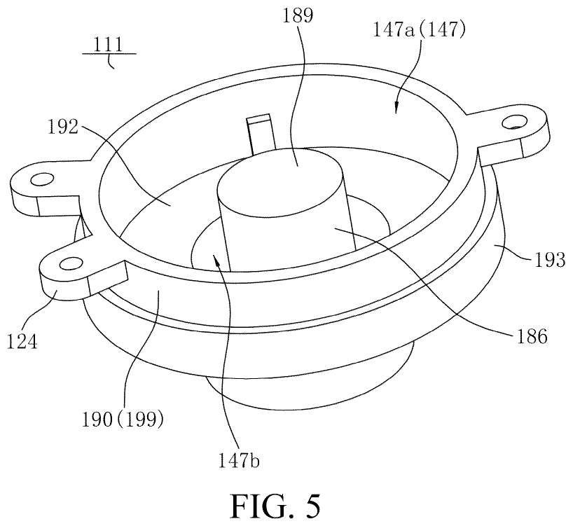

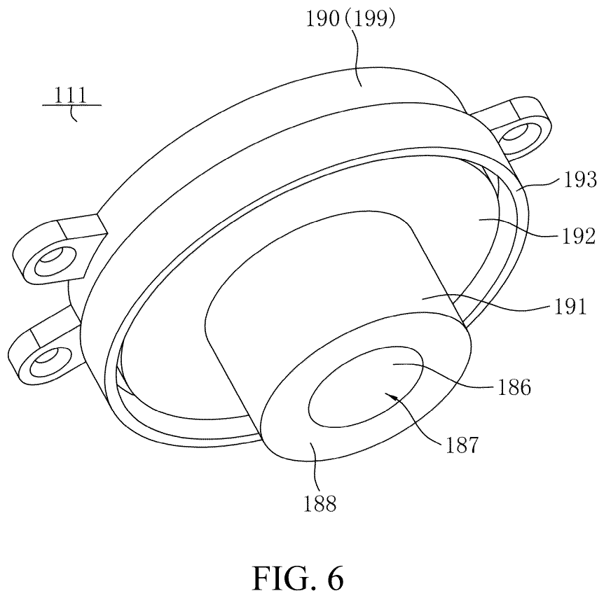

FIG. 1 is a perspective view of a fishing reel as viewed from a second end portion 103. FIG. 2 is a perspective view of the fishing reel as viewed from a first end portion 102. FIG. 3 is a sectional view of the fishing reel at the first end portion 103. In FIG. 3, a section is taken along a rotation center O1 of spool shaft 108. In addition, for convenience of illustration, a structure on the side of the first end portion 102 is mainly illustrated. FIG. 4 is a schematic diagram that simplifies FIG. 3 and mainly illustrates mounting of an end cover 111 and a brake system 106. FIG. 5 and FIG. 6 are perspective views of the end cover 111.

Referring to FIG. 1 to FIG. 6, a fishing reel according to the embodiment is described.

Mainly referring to FIG. 3 and FIG. 4, the fishing reel according to the embodiment can be a baitcasting reel, for example. The fishing reel according to the embodiment generally comprises a body 101, a first end portion 102, a second end portion 103, a spool portion 104, a handle 105, a rotation transmission mechanism (not shown) for transmitting a rotation motion of the handle 105 to the spool portion 104, and a brake system 106 for braking rotation of the spool portion 104. The body 101 serves as a whole frame to support the fishing reel. The first end portion 102 is mounted at an axial end of the body 101, and furthermore, the brake system 106 is mainly mounted at the first end portion 102. The second end portion 103 is mounted at the other axial end of the body 101, and furthermore, the rotation transmission mechanism is accommodated in the second end portion 103. The handle 105 is mounted on an axial outer side of the second end portion 103 (that is, the side opposite to the body 101), and the handle 105 is in transmission connection with the spool portion 104 via the rotation transmission mechanism. A specific structure of the rotation transmission mechanism may be, for example, a well-known gear transmission mechanism of the existing fishing reel, so the structure will not be described in detail here. The spool portion 104 is rotatably mounted on the first end portion 102 and the second end portion 103 through a shaft supporting portion 107. The shaft supporting portion 107 is provided with two bearings 107a, one of the bearings 107a is mounted at the first end portion 102, and the other one is mounted at the second end portion 103 coaxially with the first end portion 102. The bearings 107a may be, for example, a high-precision ball bearing, a roller bearing, an angular contact ball bearing and the like. The spool portion 104 is provided with a spool shaft 108 and a spool cylinder 109 coaxially sleeved over the spool shaft 108 and rotating together with the spool shaft 108, and the spool shaft 108 of the spool portion 104 and the handle 105 are connected via the rotation transmission mechanism. In addition, both axial ends of the spool shaft 108 are rotatably mounted on the bearings 107a, so that when the handle 105 rotates, the spool shaft 108 and the spool cylinder 109 rotate together. A fishing line is wound around the spool cylinder 109, and the fishing line is retrieved or released with the rotation of the spool cylinder 109.

The first end portion 102 is provided with an end cover 111 and a side cover 112. The first end portion 102 of the fishing reel according to the embodiment is mounted to the body 101 by, for example, snap-fit method, via the side cover 112, thus the end cover 111 is mounted to an axial end of the body 101. The end cover 111 is generally disc-shaped when viewed from the top. The end cover 111 can be mounted to the side cover 112 by a well-known connection structure such as screw connection, and the side cover 112 covers the end cover 111 from an outer side of the end cover 111. A knob 118 is rotatably mounted on the side cover 112, and the knob 118 is connected with a braking-dial input portion 117 of a control panel 116 of the brake system 106 via a connecting shaft 120 accommodated in a space 127 formed between the side cover 112 and the end cover 111. Thus, a level of a braking force is adjusted by rotating the knob 118.

Mainly referring to FIG. 3 and FIG. 4, with auxiliary reference to FIG. 5 and FIG. 6, in the fishing reel according to the embodiment, the end cover 111 is an integrally formed member, for example, the end cover 111 may be injection-molded by a resin material with high strength. The end cover 111 is formed with a first wall portion 186, and a radial inner side of the first wall portion 186 is formed with an accommodating cavity 187. The bearings 107a of the shaft supporting portion 107 is embedded in the accommodating cavity 187. An axial end of the spool shaft 108 of the spool portion 104 is rotatably supported on the bearing 107a in the accommodating cavity 187. Moreover, the brake system 106 is provided with a coil 114 and a magnet 115. The coil 114 is mounted onto the first wall portion 186, the magnet 115 is mounted onto the spool shaft 108, and the coil 114 and the magnet 115 are opposite to each other along the radial direction of the spool shaft 108.

According to the fishing reel according to the embodiment, assembly precision can be improved. In the fishing reel of the embodiment, the end cover 111 is formed with the first wall portion 186, and an accommodating cavity 187 for mounting the bearing 107a, which is intended for mounting the shaft supporting portion 107, is defined by the first wall portion 186, so that an axial end of the spool shaft 108 can be installed on the bearing 107a. Furthermore, by directly mounting the coil 114 on the first wall portion 186 as a mounting reference for the spool shaft 108 and mounting the magnet 115 on the spool shaft 108, assembly parts required between the coil 114 and the magnet 115 can be reduced. Further, a cumulative error of assembly between the parts can be reduced and the assembly precision can be improved. Thus, a coaxiality of the mounting of the coil 114 relative to the magnet 115 can be improved.

In addition to the first wall portion 186, the end cover 111 is also formed with a second wall portion 199 around a radial outer side of the first wall portion 186, a first sealing wall 188 sealing the first wall portion 186 and the second wall portion 199 at an end of the first wall portion 186 and the second wall portion 199 adjacent to an opening of the accommodating cavity 187, and a second sealing wall 189 sealing the accommodating cavity 187 at an end opposite to the first sealing wall 188. The first wall portion 186, the second wall portion 199 and the first sealing wall 188 together form the mounting cavity 147. The mounting cavity 147 is configured to accommodate the coil 114 and the control panel 116 of the brake system 106, and the mounting cavity 147 may be sealed, for example, by well-known sealing means such as glue injection. The second sealing wall 189 seals the accommodating cavity 187 at an end of an axial outer side of the first wall portion 186, i.e., the end opposite to the first sealing wall 188, so that the accommodating cavity 187 and the mounting cavity 147 are isolated from each other.

The first wall portion 186 is formed in a cylindrical shape, and a radial inner side wall surface of the first wall portion 186 facing the accommodating cavity 187 is a smooth wall surface. the first wall portion 186 defines the radial inner side wall surface having a radius r1 larger than a rotation radius r2 of the magnet 115, with the difference constrained within a range of 0.30 mm to 0.50 mm, wherein the rotation radius r2 is a distance between a farthest position of the magnet 115 installed on the spool shaft 108 in the radial direction to a rotation center O1 of the spool shaft 108 and a rotation center of the spool shaft 108. In addition, a radial outer side wall surface of the first wall portion 186 facing the mounting cavity 147 is also a smooth wall surface. The first wall portion 186 has a wall thickness of, for example, 0.50 mm to 1 mm.

The second wall portion 199 defines: a first outer side wall 190, a second outer side wall 191 and a base portion 192 connecting the first outer side wall 190 and the second outer side wall 191. The first outer side wall 190 and the second outer side wall 191 are annular respectively. The first outer side wall 190 surrounds an axial part of the first wall portion 186 close to the side cover 112. The first outer side wall 190 has a wall thickness greater than that of the first wall portion 186, and may be, for example, in a range of 1 mm to 3 mm. Between the first outer side wall 190 and the first wall portion 186, a first cavity 147a in the mounting cavity 147 is defined in the radial direction, and the first cavity 147a is configured for receiving the control panel 116 of the brake system 106. A mounting lug(s) 124 is formed in a circumferential direction of the first outer side wall 190, and the end cover 111 is mounted to the side cover 112 via the mounting lug(s) 124. An outer diameter of the second outer side wall 191 is smaller than that of the first outer side wall 190. The second outer side wall 191 coaxially surrounds the first wall portion 186 at its axial portion near a middle portion of the body 101. A wall thickness of the second outer side wall 191 may be the same as that of the first wall portion 186, but the wall thickness of the second outer side wall 191 may be larger than that of the first wall portion 186 from the viewpoint of overall strength of the second wall portion 199. Between the second outer side wall 191 and the first wall portion 186, a second cavity 147b in the mounting cavity 147 is defined in the radial direction, and the second cavity 147b is fluidly communicated with the first cavity 147a, and is configured for accommodating the coil 114 of the brake system 106. Specifically, the coil 114 is mounted to the first wall portion 186 in the second cavity 147b. A wall thickness of the base portion of the second wall portion 199 may be greater than that of the first wall portion 186, and may be, for example, 1 mm to 3 mm. The base portion 192 is located at a substantially middle position of the first wall portion 186 in the axial direction of the end cover 111. The base portion 192 connects one end of an axial inner side of the first outer side wall 190 (that is, the end facing the axial middle of the body 101) and one end of an axial outer side of the second outer side wall 191 (that is, the end facing the side cover 112), so that a side of the mounting cavity 147 relative to the axial middle of the body 101 is sealed. In addition, a side of the mounting cavity 147 facing the side cover 112 is open.

The second sealing wall 189 seals the first wall portion 186 at an end facing the side cover 112 in the axial direction, thereby forming the accommodating cavity 187. The second sealing wall 189 has a substantially disc-shaped flat plate shape. A plate thickness of the second sealing wall 189 is greater than that of the first wall portion 186, and may be, for example, 1 mm to 3 mm. the second sealing wall 189 defines a bearing installation surface for mounting the bearing 107a at its side facing the accommodating cavity 187, and the bearing 107a is abutted against the second sealing wall 189 in the accommodating cavity 187. The other side of the second sealing wall 189 opposite to the side cover 112 is planar, and the side of the second sealing wall 189 opposite to the side cover 112 does not protrude from an end face of the first outer side wall 190 opposite to the side cover 112 in the axial direction.

In addition, the end cover 111 is also formed with a shielding cover 193. The shielding cover 193 may be integrally formed around the first outer side wall 190 of the second wall portion 199. The shielding cover 193 and the first wall portion 186 extend coaxially towards an opening side of the accommodating cavity 187. Compared with the base portion 192 of the second wall portion 199, the shielding cover 193 extends toward the first sealing wall 188 in the axial direction (that is, toward an axial middle portion of the body). The shielding cover 193 protrudes from the base portion 192, for example, by 1 mm to 3 mm. The shielding cover 193 is annular, and the shielding cover 193 surrounds the first outer side wall 190. In the radial inner side surface of the shielding cover 193 (i.e., the side opposite to the second outer side wall 191), at least a part of the surface protruding from the base portion 192 is a smooth surface.

With continued reference to FIG. 3 and FIG. 4, the fishing reel according to the embodiment further comprises a reinforcing cover plate 194. The reinforcing cover plate 194 is mounted in the first cavity 147a of the mounting cavity 147. The reinforcing cover plate 194 has a circular cover shape. The reinforcing cover plate 194 is formed with a reinforcing portion 195, the reinforcing portion 195 is in a flat-plate shape, and the reinforcing portion 195 has a thickness, for example, in a range of 1 mm to 3 mm. A nesting hole 196 is formed in a middle portion of the reinforcing portion 195. The nesting hole 196 has an inner diameter the same as the outer diameters of the first wall portion 186 and the second sealing wall 189. The reinforcing cover plate 194 passes through the second sealing wall 189 through the nesting hole 196 and is sleeved over the first wall portion 186 at an end adjacent to the second sealing wall 189. The nesting hole 196, the first wall portion 186 and the second sealing wall 189 are clearance-fitted by seven or eight levels of fitting tolerance. An annular abutting portion 197 is formed on an edge of the reinforcing cover plate 194, and the abutting portion 197 protrudes perpendicular to the reinforcing portion 195. An outer diameter of the abutting portion 197 is the same as an inner diameter of a part of the second wall portion 199 adjacent to the abutting portion 197 in the radial direction, that is, the outer diameter of the abutting portion 197 is the same as the inner diameter of the first outer side wall 190 in the second wall portion 199. Between an outer peripheral edge of the abutting portion 197 and an inner periphery of the first outer side wall 190, clearance fitting is performed by eight or nine levels of fitting tolerance. In the state that the reinforcing cover plate 194 is mounted in the first cavity 147a, the reinforcing cover plate 194 is sleeved over the first wall portion 186 through the nesting hole 196, and the abutting portion 197 of the reinforcing cover plate 194 is abutted against the base portion 192 of the end cover 111. Further, the reinforcing cover plate 194 covers the control panel 116 in such a way that the abutting portion 197 surrounds the control panel 116.

In addition, the reinforcing cover plate 194 may define an avoidance hole (not marked with a reference numeral) allowing the connecting shaft 120 to be connected with the braking-dial input portion 117 of the control panel 116. In an assembled state where the reinforcing cover plate 194 covers the control panel 116, a gap between the nesting hole 196 of the reinforcing cover plate 194 and the first wall portion 186 and/or the second sealing wall 189 can be sealed by way of, for example, filling encapsulation resin. In addition, a gap between the avoidance hole of the reinforcing cover plate 194 and the connecting shaft 120 is sealed by embedding a sealing ring. Thus, the entire mounting cavity 147 of the end cover 111 is sealed.

As described above, the spool portion 104 is provided with the spool shaft 108 and the spool cylinder 109 which is sleeved over the spool shaft 108 and rotates coaxially with the spool shaft 108, the fishing line is wound around the spool cylinder 109, and the fishing line is retrieved or released with the rotation of the spool cylinder 109. In the assembled state, one axial end of the spool cylinder 109 is opposite to the end cover 111. An annular flange portion 198 is formed at the end of the spool cylinder 109 corresponding to the end cover 111, and an outer surface of the flange portion 198 is a smooth surface. The flange portion 198 faces the shielding cover 193 formed around the first outer side wall 190 of the second wall portion 199 of the end cover 111, and the flange portion 198 extends into a space formed by the shielding cover 193 and is surrounded by the shielding cover 193. As a result, there is an overlapping part between the shielding cover 193 and the flange portion 198 in the axial direction. In the part where the shielding cover 193 and the flange portion 198 overlap each other in the axial direction, an outer diameter D1 of the flange portion 198 is smaller than an inner diameter D2 of the shielding cover 193, but is only smaller by 0.30 to 0.40 mm, so that a gap between the shielding cover 193 and the flange portion 198 in the radial direction is in a range of 0.15 mm to 0.20 mm.

In the fishing reel according to the embodiment, the first wall portion 186 is formed in the end cover 111, and an accommodating cavity 187 for receiving the bearing 107a of the shaft supporting portion 107 is formed at the inner side the first wall portion 186, so that an axial end of the spool shaft 108 can be mounted on the bearing 107a. Furthermore, by directly mounting the coil 114 on the first wall portion 186 as the mounting reference for the spool shaft 108 and mounting the magnet 115 on the spool shaft 108, the assembly parts required between the coil 114 and the magnet 115 can be reduced. Further, the cumulative error of assembly between the parts can be reduced and the assembly precision can be improved. Thus, the coaxiality of the installation of the coil 114 relative to the magnet 115 can be improved.

In addition, by reducing the parts, a cost can be saved and an assembly process can be simplified.

In the fishing reel according to the embodiment, by forming the mounting cavity 147 and the accommodating cavity 187 which are fluidly communicated but isolated from each other, the brake system 106 for the fishing reel can be reliably mounted, and members (such as the control panel 116 and the coil 114) that need to be sealed can be easily sealed in the mounting cavity 147.

In the fishing reel according to the embodiment, the second sealing wall 189 does not protrude from the end face of the second wall position 199 opposite to the first sealing wall 188 in the axial direction, the space 127 formed between the side cover 112 and the end cover 111 can be enlarged, so that other members (such as the rotating shaft 120) can be compactly accommodated, and it is not necessary to make the side cover 112 protrude too much in the axial direction, which will affect a gripping feeling of a user.

In the fishing reel according to the embodiment, the radius r1 of the radial inner side wall surface of the first wall portion 186 is larger than the rotation radius r2 of the magnet 115 by only 0.30 mm to 0.50 mm, so that the magnet 115 and the coil 114 can be closer, and a magnetic field can be strengthened. In addition, the first wall portion 186 and the spool shaft 108 have a high coaxiality. In this way, even if a gap between the inner side wall surface of the first wall portion 186 and the magnet 115 is small (for example, 0.15 mm), the friction between the magnet 115 and the inner side wall surface of the first wall portion 186 can be suppressed.

In the fishing reel of the embodiment, the outer diameter D1 of the flange portion 198 is larger than the inner diameter D2 of the shielding cover 193 by only 0.30 to 0.40 mm in the part where the shielding cover 193 formed in the end cover 111 and the flange portion 198 formed in the spool cylinder 109 overlap each other in the axial direction, so that the fishing line can be prevented from being caught in the end cover 111 due to backlash of fishing line. In addition, the end cover 111 is integrally provided with the shielding cover 193 and the first wall portion 186 for mounting the spool shaft 108, so that the coaxiality between the shielding cover 193 and the first wall portion 186 and the coaxiality between the shielding cover 193 and the flange portion 198 can be ensured, and even if the gap between the shielding cover 193 and the flange portion 198 is small (for example, 0.15 mm), the shielding cover 193 and the flange portion 198 can be suppressed.

In the fishing reel of the embodiment, the reinforcing cover plate 194 is sleeved over the first wall portion 186, so that a strength of the first wall portion 186, which is the position where the bearing 107a is mounted in the end cover 111, can be improved, and deformation, cracking and the like of the first wall portion 186 can be suppressed.

Furthermore, the outer diameter of the abutting portion 197 of the reinforcing cover plate 194 is the same as the inner diameter of the portion of the second wall portion 199 adjacent to the abutting portion 197 in the radial direction, and thus the first wall portion 186 and the second wall portion 199 can be connected via the reinforcing cover plate 194, thereby further improving the strength of the first wall portion 186 and suppressing the deformation or cracking of the first wall portion 186.

It should be noted that in the above embodiment, an example in which the magnet 115 of the brake system 106 is mounted on the spool shaft 108 and the coil 114 is mounted on the first wall portion 186 is explained, but it is not limited to this. Actually, as long as the coil 114 can be effectively waterproof, the coil 114 may be mounted on the spool shaft 108, and the magnet 115 may be mounted on the first wall portion 186.

In the above embodiment, an example in which the end cover 111 is formed with the second wall portion 199 and the first sealing wall 188, and the mounting cavity 147 is formed by the first wall portion 186, the second wall portion 199 and the first sealing wall 188 together is explained, but it is not limited to this. As long as the control panel 116 of the brake system 106 can be mounted and effectively waterproof, the end cover 111 does not need to form the second wall portion 199 and the first sealing wall 188. In this case, for example, the end cover 111 may be formed with a flat base plate, and the first wall portion 186 perpendicular to the base portion 192 may be formed on the base plate. The control panel 116 may be directly sealed on the base plate by means of glue injection.

In the above embodiment, an example in which the shielding cover 193 is integrally formed around the first outer side wall 190 of the second wall portion 199 is described, but it is not limited to this. For example, the shielding cover 193 may be formed at the base portion 192 of the second wall portion 199. Alternatively, when the end cover 111 does not have the second wall portion 199 itself, the shielding cover 193 may be directly formed from a base plate of the end cover 111.

In the above embodiment, an example in which the fishing reel has the reinforcing cover plate 194 is explained, but it is not limited to this. As long as the strength of the end cover 111 is sufficient, the fishing reel may not be provided with the reinforcing cover plate 194.

In addition, an example in which the reinforcing cover plate 194 is provided with the abutting portion 197 is described, but it is not limited to this. For example, a protrusion that can be configured to support the reinforcing cover plate 194 so that there is a gap between the reinforcing cover plate 194 and the control panel 116 may also be formed in the mounting cavity 147.

Although the embodiments of the present disclosure have been shown and described, those of ordinary skills in the art may understand that various changes, amendments, substitutions and modifications can be made to these embodiments without departing from the principles and purposes of the present disclosure, and the scope of the present disclosure is limited by the claims and equivalents thereof.

What is claimed is:

1. A fishing reel, comprising:
a body;
an end cover installed at an axial end of the body, wherein the end cover is formed with a first wall portion, and the first wall portion defines an accommodating cavity at a radial inner side thereof;
a bearing embedded in the accommodating cavity;
a spool portion provided with a spool shaft, wherein the spool shaft is rotatably supported on the bearing in the accommodating cavity at an axial end thereof; and
a brake system provided with a coil and a magnet, wherein the coil is mounted on one of the first wall portion and the spool shaft, the magnet is mounted on the other of the first wall portion and the spool shaft, and the coil and the magnet are opposite to each other along the radial direction of the spool shaft.

2. The fishing reel according to claim 1, wherein the end cover is further formed with:
a second wall portion surrounding the first wall portion;
a first sealing wall sealing an opening defined by the first wall portion and the second wall portion at a first end of the first wall portion and a second end of the second wall portion adjacent to an opening of the accommodating cavity; and
a second sealing wall sealing the accommodating cavity at a further end opposite to the first sealing wall, wherein:
the first wall portion, the second wall portion and the first sealing wall together define a mounting cavity; and
the second sealing wall isolates the accommodating cavity and the mounting cavity from each other.

3. The fishing reel according to claim 2, wherein the second sealing wall does not extend beyond an end face of an axial end of the second wall portion opposite to the first sealing wall.

4. The fishing reel according to claim 2, wherein the coil is accommodated in the mounting cavity and mounted on the first wall portion;
the magnet is mounted on the spool shaft; and
the coil and the magnet face each other across the first wall portion.

5. The fishing reel according to claim 4, wherein the first wall portion defines a radial inner side wall surface with a radius larger than a rotation radius of the magnet by 0.30 mm to 0.50 mm.

6. The fishing reel according to claim 1, wherein the end cover is further formed with a shielding cover, and the shielding cover and the first wall portion extend coaxially towards an opening side of the accommodating cavity;
the spool portion is provided with a spool cylinder coaxial with the spool shaft, an annular flange portion is formed on an end of the spool cylinder corresponding to the shielding cover, and the flange portion extends into the shielding cover; and
in a portion at which the shielding cover and the flange portion overlap each other in the axial direction, an outer diameter of the flange portion is smaller than an inner diameter of the shielding cover by 0.30 mm to 0.40 mm.

7. The fishing reel according to claim 2, further comprising a reinforcing cover plate, wherein the reinforcing cover plate is mounted in the mounting cavity and sleeved over the first wall portion.

8. The fishing reel according to claim 7, wherein the reinforcing cover plate defines a nesting hole in a middle portion thereof, an inner diameter of the nesting hole is the same as an outer diameter of the first wall portion, and the reinforcing cover plate is sleeved over the first wall portion through the nesting hole.

9. The fishing reel according to claim 8, wherein an annular abutting portion is formed on an edge of the reinforcing cover plate, and an outer diameter of the abutting portion is the same as an inner diameter of a part of the second wall portion adjacent to the abutting portion in the radial direction.

10. The fishing reel according to claim 9, wherein the brake system further comprises a control panel, and the reinforcing cover covers the control panel in such a way that the abutting portion surrounds the control panel.

11. The fishing reel according to claim 2, wherein the end cover is further formed with a shielding cover, and the shielding cover and the first wall portion extend coaxially towards an opening side of the accommodating cavity;
the spool portion is provided with a spool cylinder coaxial with the spool shaft, an annular flange portion is formed on an end of the spool cylinder corresponding to the shielding cover, and the flange portion extends into the shielding cover; and
in a portion at which the shielding cover and the flange portion overlap each other in the axial direction, an outer diameter of the flange portion is smaller than an inner diameter of the shielding cover by 0.30 mm to 0.40 mm.
